(19) United States
(12) Patent Application Publication
(10) Pub. No.: US 2012/0314884 A1
(43) Pub. Date: Dec. 13, 2012

(54) PORTABLE STREAMING MEDIA DEVICE

(76) Inventors: Frank S. Holman, III, Woodinville, WA (US); James L. Holman, Tacoma, WA (US)

(21) Appl. No.: 13/490,193

(22) Filed: Jun. 6, 2012

Related U.S. Application Data
(60) Provisional application No. 61/494,303, filed on Jun. 7, 2011.

(51) Int. Cl. G06F 15/16; H04B 3/00

(52) U.S. Cl. 381/77; 709/219

(57) ABSTRACT

A portable streaming media device connects to a wireless network, connects to a media stream (e.g., an audio stream or video stream) associated with a streaming media channel identified by channel information stored in memory, and processes the media stream for playback. The device can interpret input events based on the current input mode. In a playback control input mode, the device adjusts a playback parameter (e.g., playback volume) responsive to input that corresponds a hardware button being pressed. In a channel-selection input mode, the device connects to a new media stream responsive to input that corresponds one or more hardware buttons being pressed. A power-up event can be initiated by connection of an output device (e.g., earphones) to the portable streaming media device.

### CROSS-REFERENCE TO RELATED APPLICATION

This application claims the benefit of U.S. Provisional Application No. 61/494,303, filed Jun. 7, 2011, the entire disclosure of which is incorporated herein by reference.

### BACKGROUND

Portable digital devices have become an integral part of life at home, at work, and while traveling. Some general-purpose portable digital devices (e.g., smart phones, tablet computers, and laptop computers) allow users to wirelessly stream media data to their devices over networks such as the Internet. However, users of general-purpose portable digital devices typically must perform several steps before they are able to begin streaming the desired media. For example, in a typical usage scenario, if a tablet computer user decides to listen to music on a streaming audio channel, the user must first power up the tablet computer, connect to a network (which may involve providing a network password), launch a Web browser or other application in order to connect to a server, and select the desired audio channel before they are able to actually stream the data from the server to the tablet computer. In this usage scenario, the large number of steps between the user's decision to access content and the actual delivery of the content to the user detracts from the user's experience and makes the usage scenario less attractive for content providers, advertisers, and other parties that might seek to establish a relationship with the user. For example, a smart phone user that spends ten minutes standing in line at a coffee shop offering free access to a Wi-Fi network is unlikely to perform all the tasks that are necessary in order to listen to streaming audio, even if they would prefer to be listening to music or a spoken-word broadcast while they wait.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In one aspect, a portable streaming media device connects to a wireless network (e.g., a Wi-Fi network with a stronger signal than other available networks) in response to a power-up event; connects to a media stream (e.g., an audio stream or video stream) associated with a streaming media channel identified by channel information stored in memory; and processes the media stream for playback. The portable streaming media device can interpret input events such as button presses based on a current input mode. In a playback control input mode, the portable streaming media device adjusts a playback parameter (e.g., playback volume) responsive to input that corresponds a hardware button being pressed. The portable streaming media device switches to a channel-selection input mode responsive to input that corresponds to two hardware buttons being pressed at the same time. The portable streaming media device can connect to a second media stream associated with a second streaming media channel identified by second channel information stored in the memory (e.g., in response to a one-button press or a two-button press). The portable streaming media device can switch input modes (e.g., in response to a two-button press). A power-up event can be initiated by connection of an output device (e.g., earphones) to the portable streaming media device. For example, a power-up event can occur when an a plug is inserted into an audio jack, thereby turning on the portable streaming media device.

In another aspect, a portable computing device comprises an output device connector (e.g., an audio jack) configured to turn on the computing device when an output device (e.g., a set of earphones) is connected to the output device connector; a wireless communication module configured to connect to and communicate with wireless networks in response to a power-up event; a memory having stored therein a list of streaming media channels; a processing module configured to obtain and process streaming media information received from at least one of the streaming media channels via the wireless communication module; and exterior hardware buttons configured to control one or more playback parameters in a first input mode and to control streaming media channel selection in a second input mode. The exterior hardware buttons can be configured to increase or decrease playback volume in the first input mode, and select a next streaming media channel or a previous streaming media channel from the list of streaming media channels in the second input mode.

In another aspect, a portable computing device comprises a USB plug, an audio output jack configured to turn on the computing device when an audio output device plug is inserted into the audio output jack, and a housing. Within the housing, the portable computing device comprises a battery that can be charged when the portable computing device is connected to a power supply via the USB plug (e.g., to a computer to which the portable computing device is connected); a wireless communication module configured to connect to and communicate with wireless networks in response to a power-up event initiated by the audio output jack; a memory; and a processor configured to select streaming media channels based on channel information stored in the memory and process streaming media information received via the wireless communication module. In one embodiment, the portable computing device further comprises a detachable cap that covers the USB plug. The cap comprises a hole configured to retain a key ring or lanyard.

Channel information and network information can be configured and stored in the portable streaming media device. For example, channel information and network information can be configured by a user in a configuration program running on a computer to which the portable streaming media device is attached. The channel information and network information can be used for connecting to networks and media streams, respectively.

### DESCRIPTION OF THE DRAWINGS

The foregoing aspects and many of the attendant advantages of the present disclosure will become more readily appreciated as the same become better understood by reference to the following detailed description, when taken in conjunction with the accompanying drawings, wherein:

FIG. 1 is a perspective view of an exemplary embodiment of a portable streaming media device;

FIG. 2 is another perspective view of the portable streaming media device shown in FIG. 1;

FIG. 3 is a block diagram of an exemplary system architecture for a portable streaming media device;

FIG. 4 is a state diagram for a portable streaming media device;

FIG. 5 is a flow chart of a process in an exemplary usage scenario for a portable streaming media device;

FIG. 6 is a flow chart of an exemplary process for using a configuration program;

FIG. 7 is a diagram of an exemplary help sub-menu in a configuration program;

FIG. 8 is a diagram of an exemplary network information sub-menu in a configuration program;

FIG. 9 is a diagram of an exemplary channel information sub-menu in a configuration program;

FIG. 10 is a block diagram that illustrates an arrangement of a portable streaming media device in communication with a server via a network according to various aspects of the present disclosure; and

FIG. 11 is a block diagram that illustrates aspects of an exemplary computing device that can be used in accordance with various aspects of the present disclosure.

### DETAILED DESCRIPTION

The present disclosure describes various techniques and tools that enable consumers users to easily access streaming media data (e.g., audio data, video data, or other media data). For example, in some embodiments, a dedicated, programmable mobile device obtains and processes streaming audio data delivered via a network such as the Internet.

As used herein, the term “portable streaming media device” is used to refer to a dedicated mobile device that is configured to obtain streaming media data. For example, a portable streaming media device can search for a network connection and, once connected, obtain and process streaming media data. The particular type of network connection that is used can depend on factors such as the location of the device (e.g., whether the device is within range of a wireless local-area network (WLAN) or Wi-Fi network) and whether the device has been configured with network information that will allow the device to connect to a particular network. A portable streaming media device can be configured to automatically search for a network connection, select a network (e.g., based on signal strength or by looking for a particular network), and provide network authentication information (e.g., a password) if necessary.

The particular type or content of the streaming media information that is processed by a portable streaming media device can depend on selection of a channel. As used herein, the term “channel” refers to a source of streaming media, such as a server located on a network such as the Internet. A portable streaming media device can be configured to automatically access channel information stored on the device and connect to a channel once the device has successfully connected to a network. As used herein, the term “channel information” refers to channel locator information, channel authentication information, or other information that relates to one or more channels. Channel locator information (e.g., a uniform resource locator (URL), internet protocol (IP) address, or some other identifying information) associated with a selected channel can be used to locate and connect to a media stream. Channel authentication information (e.g., username, password, or some other authentication information) can be used to connect to a media stream if a channel requests user authentication before streaming can begin.

Network information, channel information, and other information can be stored in a portable streaming media device and accessed when needed. In some described usage scenarios, the process of connecting to a network, connecting to a channel, and processing streaming media data for output can be completed by a suitably configured portable streaming media device without any input by an end user.

As used herein, the term “stream” refers generally to a continuing flow of information delivered from one device to another over a communication link (e.g., a network connection), and is not limited to any particular content, transfer protocol, or data format. A stream may represent portions or “packets” of a larger file, such an audio file or a video file. A stream can be used for different purposes, such as delivering live content (e.g., live audio or video broadcasts) or for delivering pre-recorded content without having to deliver a larger file. A stream can be processed for playback on a device. For example, an audio stream can be processed by decoding the audio stream and rendering it for output by one or more audio output devices.

The term “streaming” can be used to refer to the process of delivering or receiving a stream. In a typical streaming media scenario, media information is buffered by the receiving device before being processed for playback in order to mitigate the possible effects of varying delivery rates. Streaming can be accomplished using any protocols suitable for streaming media such as Real-time Transport Protocol (RTP), Real-time Streaming Protocol (RTSP), Real-time Control Protocol (RTCP), other protocols, or combinations of protocols (e.g., combinations of transfer protocols and control protocols).

As used herein, terms such as “streaming media,” “media information,” and “media data” refer generally to information provided by one or more channels that digitally represents media such as video, audio, or still images, and is not limited to any particular data format. Channels can deliver a wide variety of streaming media. In some embodiments, portable streaming media devices are configured to receive and process streaming audio (e.g., music, news, talk radio, sports broadcasts, audio books, product information, or other audio content). Portable streaming media devices also can be configured to receive and process other streaming media, such as video. Example data formats and system components that process such data are described below.

The present disclosure describes various mechanisms by which portable streaming media devices can be configured and controlled. For example, flexibly configured hardware buttons are described that can be used to control playback parameters (e.g., playback volume) as well as channel selection. As another example, a graphical user interface is described that can be used for configuring portable streaming media devices to be able to connect to networks and channels. A portable streaming media device can be configured by a manufacturer, content provider, retailer, consumer, or some other entity.

Embodiments of the present disclosure may have any of a variety of benefits. One possible benefit is that users are able to access streaming media more quickly and conveniently when using a described portable streaming media device than with other portable devices (e.g., general-purpose smart phones, tablet computers, and laptop computers). Another possible benefit is that parties seeking to establish a relationship with consumers will have more direct access to users of described portable streaming media devices than users of other portable devices. For example, described portable streaming media devices can be pre-configured with channels selected by content providers, advertisers, retailers, or other parties. Such devices could be sold, loaned, or given to consumers as part of a broader marketing strategy. Such devices also could be used in a cultural or public-service scenario. For example, a visitor center could pre-configure described portable streaming devices with channels that provide information that is useful for tourists (e.g., museum guides, transportation information, health and safety information, etc.).

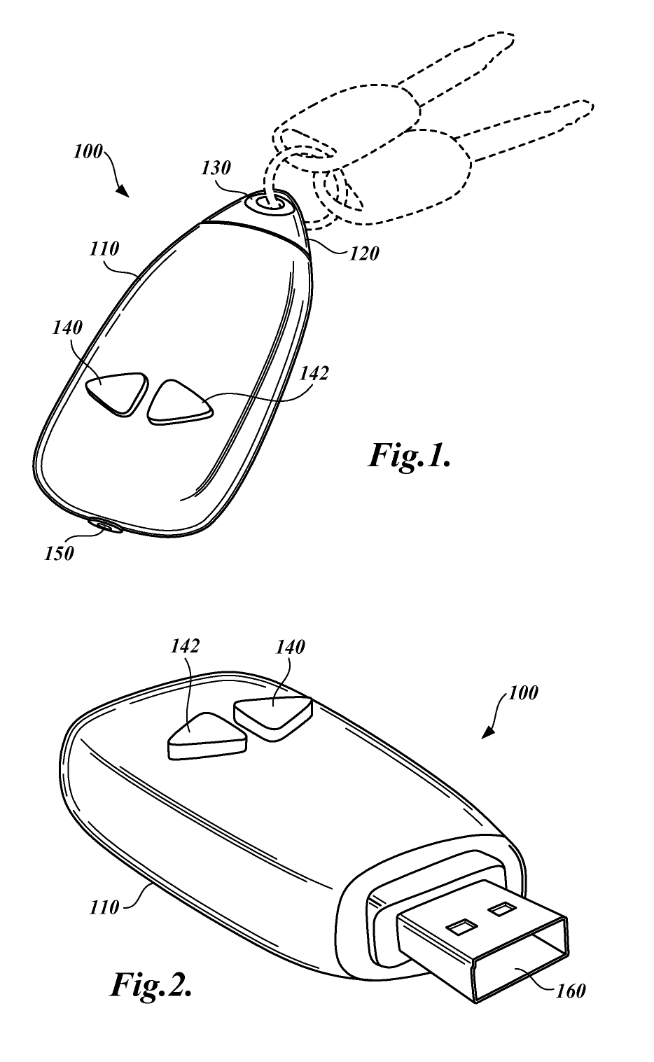

FIG. 1 is a perspective view of an exemplary embodiment of a portable streaming media device 100. As shown, the device 100 has a compact size and is easily portable. A housing 110 surrounds various functional components (not shown) that are described in further detail below. As shown, the housing 110 is configured to detachably retain a cap 120 comprising a hole 130 that can be used to connect the cap 120 to a key ring, lanyard, or other suitable item. The cap can be used as a removable cover for hardware such as a USB plug (see FIG. 2). Alternatively, the cap 120 can be omitted. As another alternative, the hole 130 or other means (such as a loop, ring, or clamp) for attaching the device 100 to another object (e.g., a key ring or lanyard) can be omitted or integrated into the device in some other way.

In the example shown in FIG. 1, the portable streaming media device 100 includes hardware buttons 140, 142. As shown, the hardware buttons 140, 142 are raised above the housing 110. Alternatively, the hardware buttons can be flush with the housing or recessed into the housing. Further, the hardware buttons can be integrated into the housing 110 or can be accessible through openings in the housing. As shown, the device 100 comprises two hardware buttons 140, 142 positioned near each other on one side of the device. Alternatively, the device 100 can have more hardware buttons, fewer hardware buttons, or different orientations or arrangements of hardware buttons. As another alternative, hardware buttons can be omitted. As another alternative, the hardware buttons 140, 142 can be replaced or supplemented with switches, a scroll wheel, or other input devices.

The hardware buttons 140, 142 can be used in one or more input modes to control functionality of the device. For example, a one-button press (where only one button is depressed at a time) of one of the hardware buttons 140, 142 can be used to control the device in a first mode, and a two-button press (where both buttons are depressed at the same time) can be used to control the device in a second mode. In some embodiments, the hardware buttons 140, 142 are used to adjust playback volume in a first input mode and to select a media channel for playback in a second input mode. In a channel-selection or “favorite channel” input mode, the buttons 140, 142 can be used to select the next channel in a list of channels, or a previous channel in a list of channels, and can be referred to as “forward” and “back” buttons. A two-button press can be used to switch between the input modes.

The output device jack 150 allows the device 100 to be connected to an output device such as earphones or external speakers (not shown). In some embodiments, the output device jack 150 also is operable to turn the device 100 on (e.g., when an output device is connected) or off (e.g., when an output device is disconnected). For example, the output device jack 150 can be a three-conductor jack having switches operable to turn on the device 100 when a plug (e.g., a TRS plug or “mini-phone” plug) is inserted into the jack. Alternatively, the device 100 may include or be compatible with other output devices. For example, the device 100 can include a display screen for viewing streaming video data.

FIG. 2 is another perspective view of the portable streaming media device 100 shown in FIG. 1. As shown in FIG. 2, the cap (not shown) has been removed to reveal a USB plug 160. The USB plug 160 can be used to connect to a variety of other devices (e.g., computers) having compatible USB ports. For example, the portable streaming media device 100 can be connected to a computer via the USB plug 160 in order to program or configure the device using a configuration program running on the computer. (Device configuration is described in further detail below.) The USB plug 160 also can be used to provide power to and/or charge a battery in the device 100. As shown, the USB plug 160 is a standard-size USB-A plug. Alternatively, the USB plug 160 can be a USB-B plug, a mini-USB plug, a micro-USB plug, or other USB or non-USB plug that provides the ability to connect to and communicate with another computing device. In alternative implementations, such as where device configuration is not needed, the USB plug 160 can be omitted.

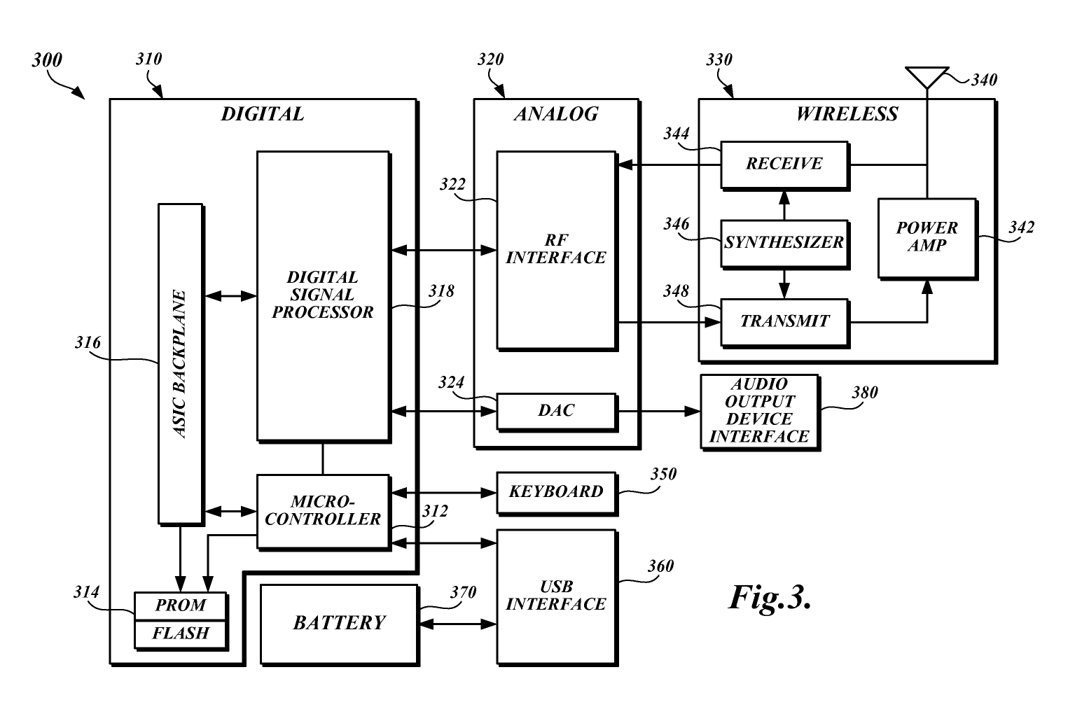

FIG. 3 is a block diagram of an exemplary system architecture 300 for a portable streaming media device. As shown, the architecture 300 includes a digital subsystem 310, an analog subsystem 320, a wireless subsystem 330, a keyboard 350 (e.g., hardware buttons), a USB interface 360, a battery 370, and an audio output device interface 380.

In the example shown in FIG. 3, the digital subsystem 310 includes a microcontroller 312, memory 314, an application specific integrated circuit (ASIC) backplane 316, and a digital signal processor (DSP) 318. The microcontroller 312 is responsible for overall functioning of the device and executes program code. The program code can include code for interpreting and responding to user input (e.g., button presses), connecting to streaming media, battery management, turning the device on or off (e.g., in response to user action such as plugging headphones into the device), or other tasks. The program code can be stored in memory 314 and/or in some other location, such as in storage located in the microcontroller itself. In a typical scenario, some data (e.g., program code for core device functions) used by the microcontroller 312 is pre-loaded into the portable streaming media device and is generally not configurable by a user, while other data (e.g., channel information, network information) can be added or configured by a user.

The memory 314 can be any suitable memory. In the example shown in FIG. 3, the memory 314 comprises programmable read-only memory (PROM) and flash memory. The type of memory used can depend on the type of information to be stored. For example, in one implementation, program code for core device functions is stored in PROM, while other information (e.g., channel information, network information) is stored in flash memory. The memory 314 can store information relating to device states. For example, the memory 314 can store user preference information such as a selected channel, volume setting, or other information that can be saved when the device is turned off and loaded again when the device is turned back on.

The ASIC backplane 316 includes a custom-built integrated circuit that can be used for overall device control, including control of wireless network processes, memory management, and other tasks. Alternatively, the ASIC backplane 316 is omitted, with any control that may have been handled by the ASIC instead being handled by other components, such as microcontroller 312.

The DSP 318 is responsible for data processing relating to streaming media functionality (e.g., media data decoding (which can include specialized decoding for different types of data, such as speech decoding), error correction, equalization, or signal demodulation). For example, the DSP can decode data that has been encoded in a format suitable for streaming media data (e.g., MP3, Vorbis, AAC, HE-AAC, or Windows Media Audio (WMA) for audio; MPEG-2/H.262, H.263, VC-1, or H.264 for video).

In the example shown in FIG. 3, the analog subsystem 320 includes a radio frequency (RF) interface 322 and a digital-to-analog converter (DAC) 324. The analog subsystem 320 handles tasks that relate to analog signal processing. For example, decoded audio data can be sent from the DSP 318 to the DAC 324 for conversion to an analog signal for output. As another example, RF interface 322 handles tasks relating to radio-frequency signals (e.g., Wi-Fi signals) that are received or transmitted (e.g., via antenna 340). For example, radio-frequency signals are converted from analog to digital in an analog-to-digital converter (ADC) when received and are converted from digital to analog in a DAC when transmitted. In practice, actual conversion of digital signals to analog signals, and vice versa, may be handled outside analog subsystem 320 (e.g., in wireless subsystem 330), depending on implementation. In the example shown in FIG. 3, the wireless subsystem 330 includes a power amplifier 342, a receiving module 344, a transmission module 348, and a synthesizer module 346. The wireless subsystem 330 processes signals for wireless communication (e.g., communication with a Wi-Fi base station). For example, the wireless subsystem 330 can operate in accordance with a IEEE 802.11 standard (e.g., 802.11g or 802.11n) in a 2.4 GHz, 3.6 GHz, or 5 GHz frequency band.

The exact functions and configurations of the elements shown in FIG. 3 can vary depending on implementation. For example, the USB interface 360 can be configured with a port that accommodates a standard-size USB-A plug, USB-B plug, a mini-USB plug, a micro-USB plug, or other USB plug. As another example, the keyboard 350 can include hardware buttons 140, 142, or other keys or buttons.

Variations of the architecture 300 shown in FIG. 3 are possible. For example, portable streaming media devices may include additional components, fewer components, different components, or different arrangements or configurations of components. Further, other features and connections between components shown in FIG. 3 are possible. As an example, if a portable streaming media device is configured to turn on when an output device (e.g., a set of headphones) is connected, the output device may be connected to a suitable output jack that is electrically coupled to a power supply (e.g., battery 370). The audio output jack can include switches operable to turn the device on when the output device is connected, or off when the device is disconnected. Further, the functionality of some components shown in FIG. 3 or other components can be provided as attached peripheral devices, and need not be integrated into a single device. For example, volume can be controlled by an in-line volume control slider or knob coupled to earphones attached to the device.

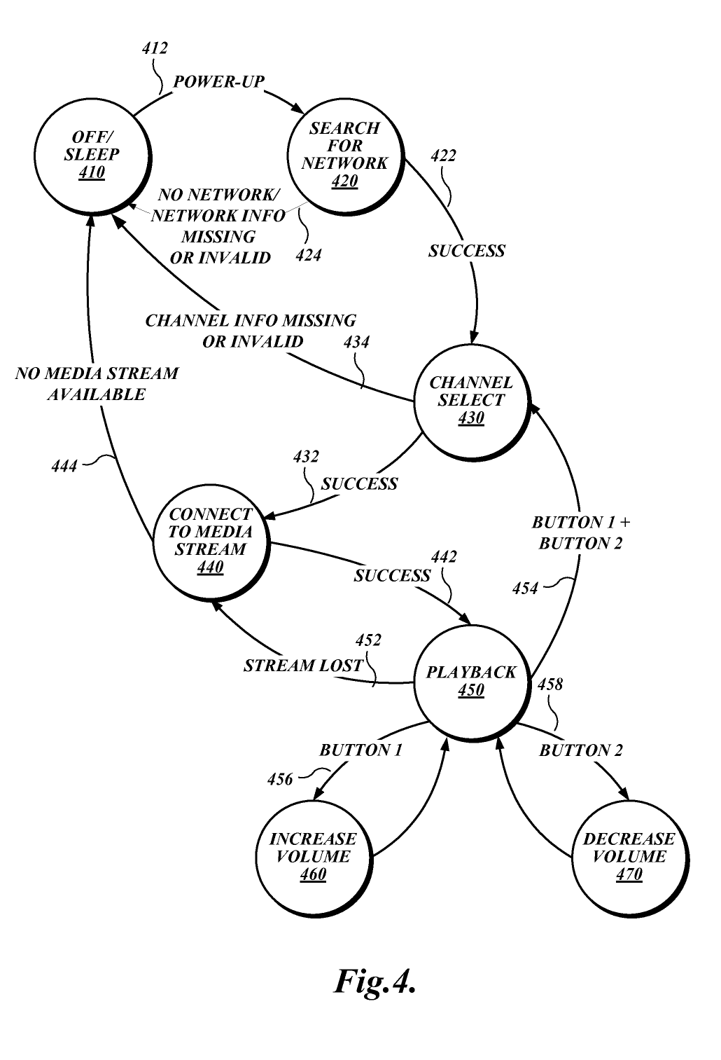

FIG. 4 is a state diagram that describes exemplary device states for a portable streaming media device along with exemplary transitions between states. For example, in one usage scenario, a portable streaming media device initially is in an off/sleep state 410. The “power-up” transition 412 (e.g., in response to connection of an audio output device or some other power-up event) takes the device to a search-for-network state 420. If the device successfully connects to a network (e.g., a Wi-Fi network), transition 422 takes the device to a channel-select state 430. If network connection is not successful (such as where no network is detected, or where network information is missing or invalid), transition 424 takes the device back to off/sleep state 410 (e.g., to conserve battery life). In the channel-select state 430, the device selects a channel. For example, the device selects a channel at the top of a list of favorite channels, or the device selects a channel that was selected the last time the device was powered down. From channel-select state 430, if the device successfully selects a valid channel (e.g., by finding a valid URL in a list of favorite channels), transition 432 takes the device to connect-to-media-stream state 440. If channel selection is not successful (such as where a channel list is empty or contains invalid channel information), transition 434 takes the device back to off/sleep state 410 (e.g., to conserve battery life). From connect-to-media-stream state 440, if the device successfully connects to a media stream (e.g., by receiving packets of encoded media information from a server), transition 442 takes the device to playback state 450. If stream connection is not successful (such as where a server fails to actually deliver the expected media information), transition 444 takes the device back to off/sleep state 410 (e.g., to conserve battery life).

In the example shown in FIG. 4, while the device is in playback state 550, a user can press a button (transitions 456, 458) to increase or decrease playback volume (states 460, 470). Or a user can press two buttons at once (transition 454) to return to channel-select state 430. In this way, the two-button press can cause the device to switch input modes (e.g., from a playback control input mode to a channel-selection input mode). In the channel-selection input mode, a one-button press can operate to select a new channel (e.g., a next channel or a previous channel in a list of favorite channels). If the stream is lost at some point during playback (e.g., if a server delivering the stream has stopped responding, or if a network connection is temporarily lost), transition 452 takes the device back to connect-to-media-stream state 440.

Various alternatives to the states and transitions shown in FIG. 4 are possible. For example, a device that fails to connect to a media stream in state 440 could return to channel-select state 430 and select (or allow a user to select) a different channel if more channels are available. As another example, a two-button press could act as a “next channel” event itself, with one-button presses used to adjust playback parameters (e.g., playback volume) by default, which could eliminate the need for switching back to a playback control input mode and potentially avoid leaving a user confused as to the current input mode. As another example, additional device states or transitions are possible, such as where more buttons, fewer buttons, or different buttons are provided for user input.

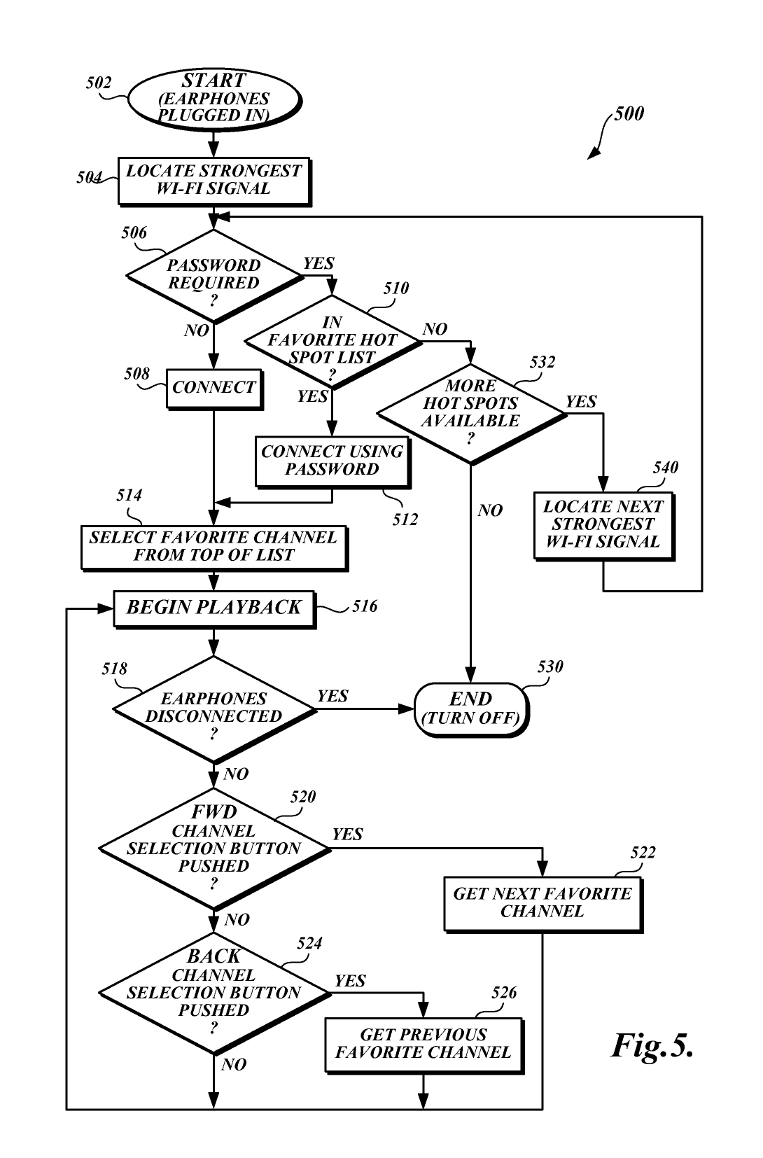

FIG. 5 is a detailed flow chart of a process 500 in an exemplary usage scenario for a portable streaming media device. At 502, the process 500 starts when earphones are plugged into the device. At 504, the device selects a network to connect to by locating a the strongest available Wi-Fi signal. At 506, the device determines whether a password is required to connect to the network. At 508, if no password is required, the device connects to the network. At 510, if a password is required, the device determines whether the network is in a list of favorite Wi-Fi networks or “hot spots.” At 512, if the network is in the list, the device connects using the password (and potentially other information, such as a username, if required). At 532, if the network is in not the list, the device determines whether other networks are available. If so, then at 540 the device selects a network associated with the next-strongest Wi-Fi signal. If no other networks are available, the device turns off at 530 (e.g., to conserve battery life).

If the device is able to connect to a network, at 514, the device selects a channel from a list (e.g., a first or top choice in a list of favorite channels, a channel that was selected the last time the device was used, or some other channel). Once connected to the channel, the device begins playback at 516. At 518, the device checks whether the earphones have been disconnected from the device, and powers off at 530 if the earphones are disconnected. At 520, if a “forward” channel selection button is pushed, the device gets a next favorite channel from the list at 522. At 524, if a “back” channel selection button is pushed, the device gets a previous favorite channel from the list at 526. Playback can then begin at 516 for the newly selected channel.

Various alternatives to the process 500 shown in FIG. 5 are possible. For example, although FIG. 5 shows that the device checks for earphone disconnection after playback begins, the device can be configured to turn off whenever earphones are disconnected, including before a channel has been selected, or before playback has begun. As another example, although FIG. 5 shows that the device checks for channel-selection input after playback begins, the device can be configured to select a new channel in response to user input at other stages, including before playback has begun. As another example, some events that can occur in various usage scenarios (e.g., playback control events) are not shown for the sake of simplicity. As another example, although FIG. 5 shows that networks are chosen based on signal strength, other selection criteria may be used in place of or in combination with signal strength. For example, a device may try to connect to a network identified in a list of favorites by default (regardless of signal strength), and then try to connect to other networks as necessary based on signal strength. As another example, although network information and channel information are indicated as appearing in lists of “favorites,” such lists need not actually represent a user's favorite networks or channels or even represent networks or channels that have been chosen by a user.

### Device Configuration

Described portable streaming media devices can be configured (e.g., by adding or modifying network information or channel information) by end users or other entities. For example, a portable streaming media device having a USB plug can connected to a USB port on a computer. Once the device is recognized, device configuration functionality can be accessed (e.g., via a browser or a dedicated device configuration application running on the computer). Configuration settings can be loaded into the portable streaming media device (e.g., via a USB interface). In one embodiment, a computer recognizes a portable streaming media device as a “USB Gadget” or “Ethernet Gadget.” For example, the Linux platform provides a “USB Gadget” API (application programming interface) framework for device drivers that can be used for described portable streaming media devices. Such drivers can interoperate with hosts running various operating systems (e.g., a Linux operating system or a Microsoft Windows operating system).

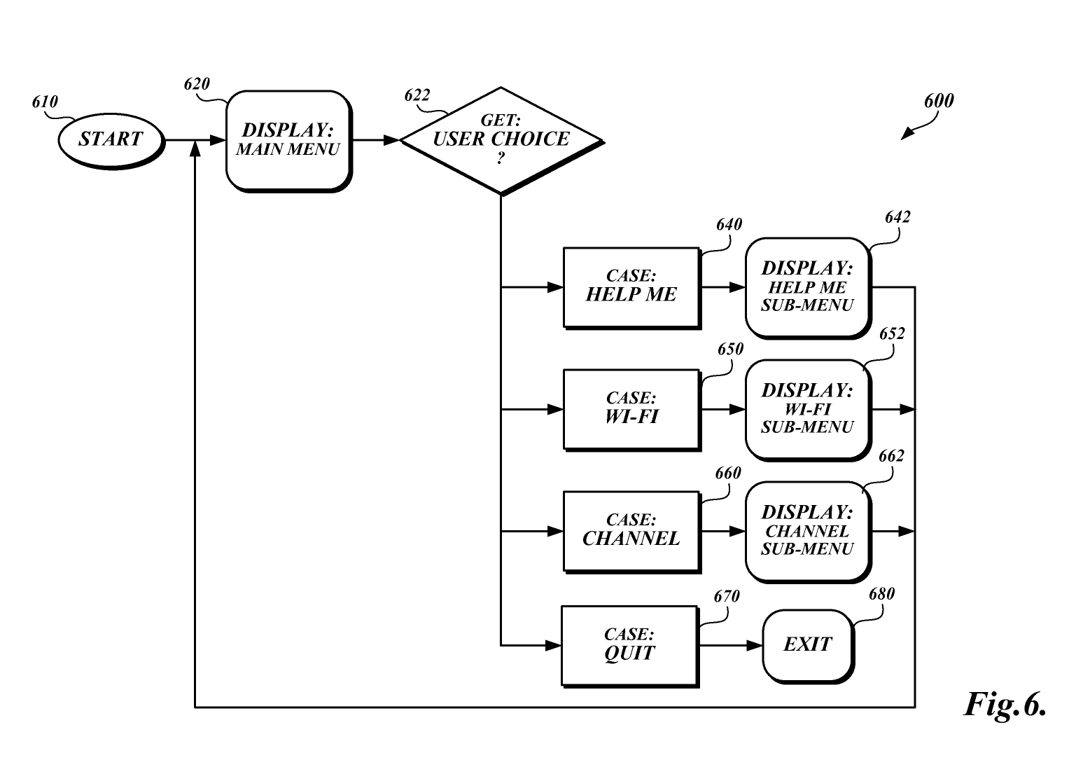

Regardless of how the device is recognized or how its configuration functionality is accessed, network information and channel information can be configured via a user interface. FIGS. 6, 7, 8 and 9 illustrate aspects of a user interface for configuring a portable streaming media device. The user interface can be presented to a user by a computer that has recognized and is able to communicate with the portable streaming media device (e.g., via a USB interface). Configuration information entered into the computer via the user interface can then be transferred to the portable streaming media device.

FIG. 6 is a flow chart that illustrates an exemplary process 600 for using a configuration program. The process starts at 610, and the computer displays a main menu at 620. From the main menu, the user can select options such as a help sub-menu, a network information sub-menu, and a channel information sub-menu. At 622, the computer receives input indicating a menu choice from a user.

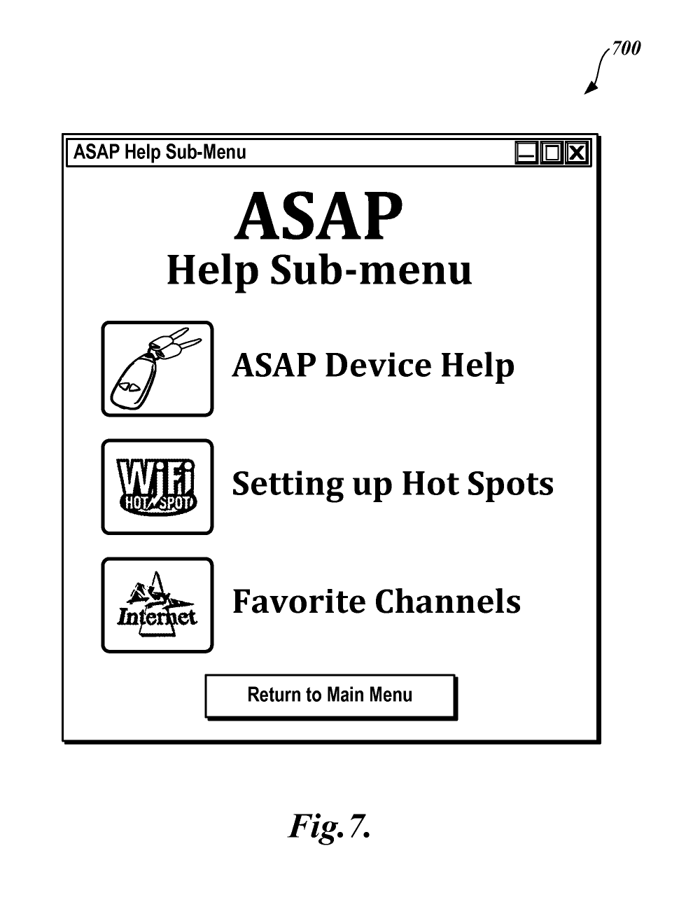

User input received at the main menu can be classified into four cases. At 640 (case: Help), the computer accesses a help sub-menu in response to user selection and displays it at 642. An exemplary help sub-menu 700 is shown in FIG. 7. The help sub-menu can be used to access descriptive information about the device and the configuration program. For example, a user can access information on usage scenarios, instructions on how to configure network information (e.g., adding a new network to a Favorite Wi-Fi Hot Spots list), and instructions on how to configure channel information (e.g., adding a new channel to a Favorite Channels list).

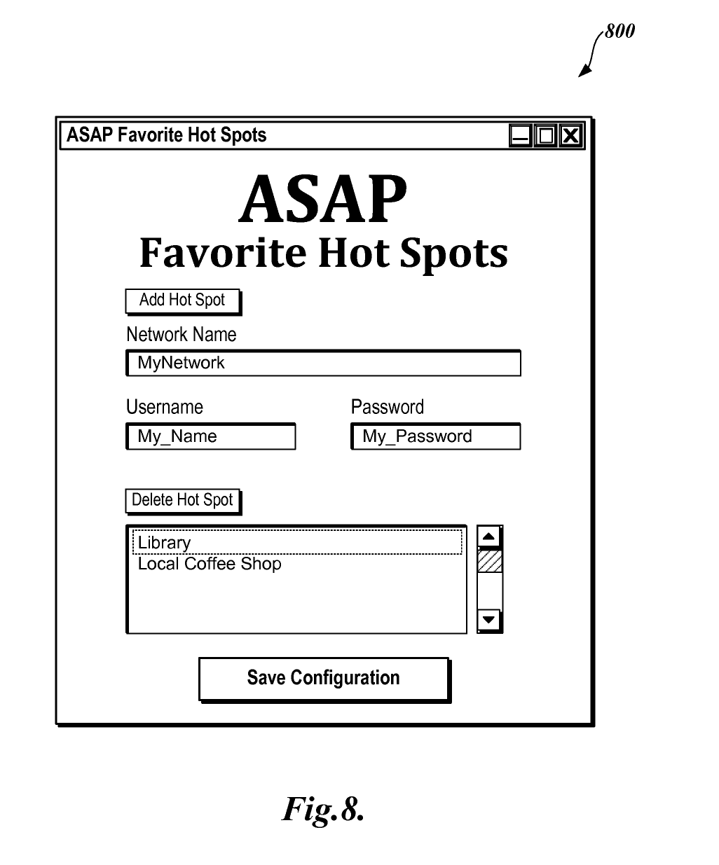

Referring again to FIG. 6, at 650 (case: Wi-Fi), the computer accesses a network information sub-menu (or Wi-Fi sub-menu) in response to user selection and displays it at 652. An exemplary network information sub-menu 800 (entitled “ASAP Favorite Hot Spots”) is shown in FIG. 8. As shown, the sub-menu 800 provides the user with the ability to define Wi-Fi Hot Spots (e.g., by adding networks, deleting networks, and saving updated configuration information). To add a network, a user can supply a network name, a username (if required), and a password (if required), and click on the “Add Hot Spot” button. The network name appears in a list that may contain several networks (e.g., up to 100) and can be navigated with a scroll bar. To delete a network, a user can highlight a network in the list and click on the “Delete Hot Spot” button. A portable streaming media device can use network information (e.g., network password) stored in the device to connect to a network (e.g., a password protected network at the user's home). Alternatively, the device can access networks even if information corresponding to such networks is not stored on the device. For example, the device can be configured to connect to any network that is not password protected, even if it does not appear in a list of favorite networks.

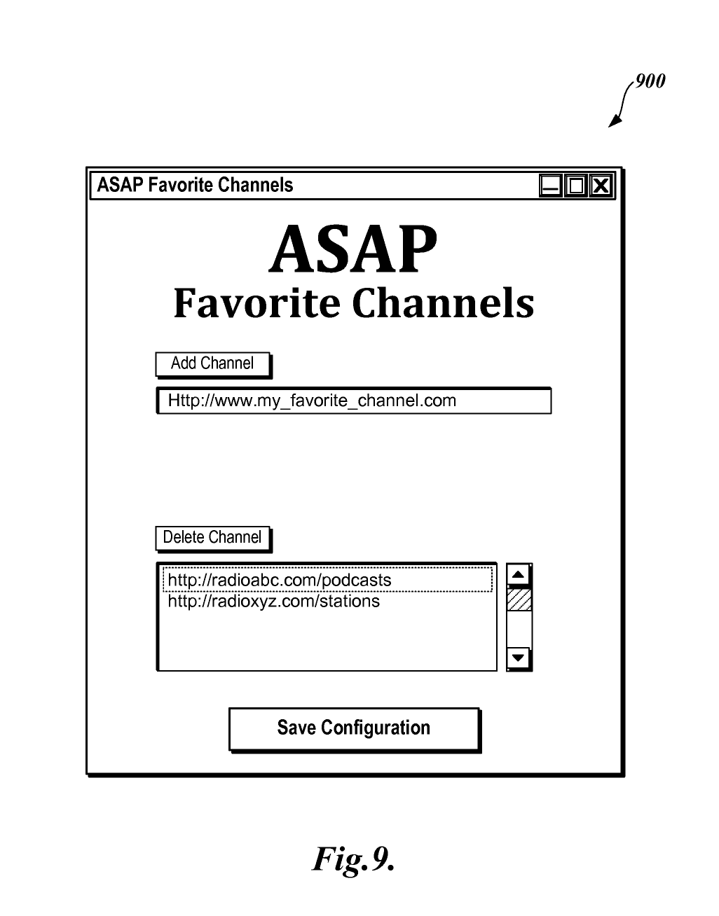

Referring again to FIG. 6, at 660 (case: Channel), the computer accesses a channel information sub-menu in response to user selection and displays it at 662. An exemplary channel information sub-menu 900 (entitled “ASAP Favorite Channels”) is shown in FIG. 9. As shown, the sub-menu 900 provides the user with the ability to define their favorite channels (e.g., by adding channels, deleting channels, and saving updated configuration information). To add a network, a user can enter a URL (e.g., by typing in the URL, or copying and pasting the URL from a browser window) and click on the “Add Channel” button. The URL appears in a list that may contain several channels (e.g., up to 100) and can be navigated with a scroll bar. To delete a channel, a user can highlight a channel in the list and click on the “Delete Channel” button. The device can select channels from this list. For example, the device can select the channel at the top of the list by default once the device has connected to a network. As another example, the device can select the next channel in the list, or the previous channel in the list, in response to user input. The device also can use information such as passwords and usernames stored in the device to connect to channels that are password-protected. To accommodate such scenarios, the sub-menu 900 can be modified from the example shown in FIG. 9 to include fields for entering username and password information, similar to the corresponding fields shown in the sub-menu 800 in FIG. 8.

Referring again to FIG. 6, at 670 (case: Quit), the computer initiates an exit process in response to user selection and exits the configuration program at 680.

Alternatively, a different user interface and/or a different configuration process can be used to configure a portable streaming media device.

### Operating Environment

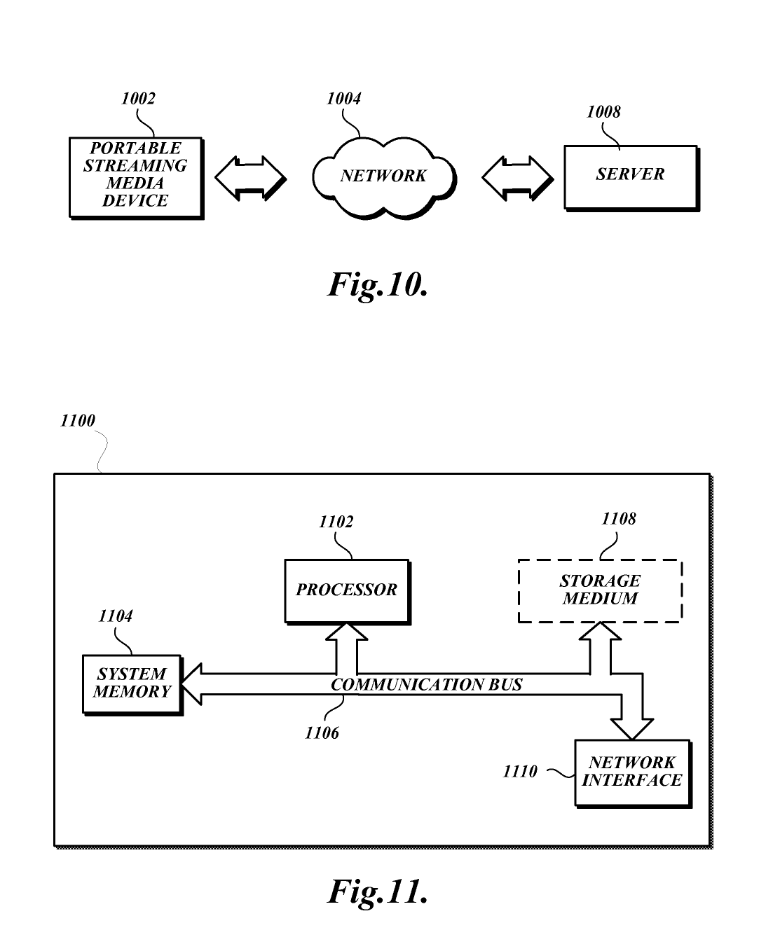

FIG. 10 is a block diagram that illustrates a portable streaming media device 1002 that communicates with a server 1008 via a network 1004 according to various aspects of the present disclosure. The network 1004 may comprise one or more sub-networks (not shown). For example, the network 1004 may comprise a local area network (e.g., a Wi-Fi network) that provides access to a wide-area network such as the

Internet. As used herein, the term “server” refers generally to a computing device that provides information (e.g., streaming media data) to a client device (e.g., a portable streaming media device) over a communication link (e.g., a network connection), and is not limited to any particular device configuration. The term “client” can be used to refer to a computing device (e.g., a portable streaming media device) that obtains information provided by a server over a communication link, and is not limited to any particular device configuration. At various times, a single device may act as a server, a client, a server and a client, or neither, depending on context and configuration. Actual physical locations of a client device and a server are not necessarily important, but the locations can be described as “local” for a client device and “remote” for a server to illustrate a common usage scenario in which a client device is receiving information provided by a server at a remote location. The server 1008 may include one or more suitable devices, such as dedicated server computing devices, or virtualized computing instances or application objects executing on a computing device.

FIG. 11 is a block diagram that illustrates aspects of an exemplary computing device 1100 appropriate for use in accordance with embodiments of the present disclosure. The description below is applicable to servers, personal computers, mobile phones, smart phones, tablet computers, embedded computing devices, and other devices that may be used in accordance with embodiments of the present disclosure. Moreover, those of ordinary skill in the art and others will recognize that the computing device 1100 may be any one of any number of currently available or yet to be developed devices.

In its most basic configuration, the computing device 1100 includes at least one processor 1102 and a system memory 1104 connected by a communication bus 1106. Depending on the exact configuration and type of device, the system memory 1104 may be volatile or nonvolatile memory, such as read only memory (“ROM”), random access memory (“RAM”), EEPROM, flash memory, or similar memory technology. Those of ordinary skill in the art and others will recognize that system memory 1104 typically stores data and/or program modules that are immediately accessible to and/or currently being operated on by the processor 1102. In this regard, the processor 1102 may serve as a computational center of the computing device 1100 by supporting the execution of instructions.

As further illustrated in FIG. 11, the computing device 1100 may include a network interface 1110 comprising one or more components for communicating with other devices over a network. Embodiments of the present disclosure may access basic services that utilize the network interface 1110 to perform communications using common network protocols. The network interface 1110 may also include a wireless network interface configured to communicate via one or more wireless communication protocols, such as WiFi, 2G, 3G, 4G, LTE, WiMAX, Bluetooth, and/or the like.

In the exemplary embodiment depicted in FIG. 6, the computing device 1100 also includes a storage medium 1108. However, services may be accessed using a computing device that does not include means for persisting data to a local storage medium. Therefore, the storage medium 1108 depicted in FIG. 11 is represented with a dashed line to indicate that the storage medium 1108 is optional. In any event, the storage medium 1108 may be volatile or nonvolatile, removable or nonremovable, implemented using any technology capable of storing information such as, but not limited to, a hard drive, solid state drive, CD-ROM, DVD, or other disk storage, magnetic cassettes, magnetic tape, magnetic disk storage, and/or the like.

As used herein, the term “computer-readable medium” includes volatile and non-volatile and removable and non-removable media implemented in any method or technology capable of storing information, such as computer readable instructions, data structures, program modules, or other data. In this regard, the system memory 1104 and storage medium 1108 depicted in FIG. 11 are examples of computer-readable media.

For ease of illustration and because it is not important for an understanding of the claimed subject matter, FIG. 11 does not show some of the typical components of many computing devices. In this regard, the computing device 1100 may include input devices, such as a keyboard, keypad, mouse, trackball, microphone, touchpad, touchscreen, stylus, and/or the like. Such input devices may be coupled to the computing device 1100 by wired or wireless connections including RF, infrared, serial, parallel, Bluetooth, USB, or other suitable connections protocols using wireless or physical connections. Similarly, the computing device 1100 may also include output devices such as a display, speakers, printer, etc. Connections such as USB connections also are suitable for connecting the computing device 1100 to other attached devices (e.g., a portable streaming media device, as described herein).

In general, functionality of computing devices described herein may be implemented in computing logic embodied in hardware or software instructions, which can be written in a programming language, such as C, C++, COBOL, JAVA™, PHP, Perl, HTML, CSS, JavaScript, VBScript, ASPX, Microsoft .NET™ languages such as C#, and/or the like. Computing logic may be compiled into executable programs or written in interpreted programming languages. Generally, functionality described herein can be implemented as logic modules that can be duplicated to provide greater processing capability, merged with other modules, or divided into sub-modules. The computing logic can be stored in any type of computer-readable medium (e.g., a non-transitory medium such as a storage medium) or computer storage device and be stored on and executed by one or more general-purpose or special-purpose processors, thus creating a special-purpose computing device configured to provide functionality described herein.

### Extensions and Alternatives

Although some examples in the present disclosure are directed to a portable streaming media device that processes media data streams, techniques and tools described herein can be modified to provide other functionality. For example, a portable streaming media device can also store (e.g., in volatile memory or in persistent storage) media data (in the form of a “podcast” or other media file) or other information, such as metadata. Stored information can be downloaded from a server or obtained in some other way. Stored information can be saved for subsequent playback or other processing in a portable streaming media device, or stored information can be delivered to another device for subsequent playback or other processing. Streaming media and other information described herein is not limited to any particular content, data format, transport protocol, or file format.

Different types of media data can be provided in combination or separately, and can be output via a variety of output devices. For example, video data can be output via display screen, touchscreen, or projector, and audio data can be output via external speakers or a personal listening device, such as over-ear or in-ear (“earbud”) headphones. Playback parameters other than volume can be controlled (e.g., by hardware buttons). For example, bitrate/signal quality for audio or video, or trick modes such as pause, fast-forward, or rewind for audio or video, can be controlled. Further, although some examples in the present disclosure include descriptions of a portable streaming media device comprising specific hardware components in a specific arrangement, techniques and tools described herein can be modified to accommodate different hardware components, combinations, or arrangements. Still further, although some examples in the present disclosure include descriptions of specific usage scenarios, techniques and tools described herein can be modified to accommodate different usage scenarios.

As will be appreciated by one skilled in the art, the specific routines described above and in the drawings may represent one or more of any number of processing strategies such as event-driven, interrupt-driven, multi-tasking, multi-threading, and the like. As such, various acts or functions illustrated may be performed in the sequence illustrated, in parallel, or in some cases omitted Likewise, unless explicitly stated, the order of processing is not necessarily required, but is provided for ease of illustration and description. Although not explicitly illustrated, one or more of the illustrated acts or functions may be repeatedly performed depending on the particular strategy being used. Features described as being implemented in hardware or firmware may instead be implemented in software, or vice-versa.

Various principles, representative embodiments, and modes of operation of the present disclosure have been described in the foregoing description. However, aspects of the present disclosure which are intended to be protected are not to be construed as limited to the particular embodiments disclosed. Further, the embodiments described herein are to be regarded as exemplary and illustrative, and not restrictive. It will be appreciated that variations and changes may be made by others, and equivalents employed, without departing from the spirit of the present disclosure. Accordingly, it is expressly intended that all such variations, changes, and equivalents fall within the spirit and scope of the claimed subject matter.

1. A computerized method comprising:
by a portable streaming media device comprising a memory, a processor, a wireless communication module, and at least two hardware buttons:
connecting to a wireless network in response to a power-up event;
via the wireless network, connecting to a first media stream associated with a first streaming media channel identified by first channel information stored in the memory;
processing the media stream for playback;
in a playback control input mode, receiving input corresponding to a first one-button press of one of the hardware buttons;
responsive to the first one-button press, adjusting a playback parameter;
receiving input corresponding to a first two-button press of two of the hardware buttons; and
responsive to the first two-button press, switching to a channel-selection input mode.

2. The computerized method of claim 1, further comprising, in the channel-selection input mode:
receiving input corresponding to a second one-button press of one of the hardware buttons; and
responsive to the second one-button press, connecting to a second media stream associated with a second streaming media channel identified by second channel information stored in the memory.

3. The computerized method of claim 1, further comprising:
receiving input corresponding to a second two-button press of two of the hardware buttons; and
responsive to the second two-button press, switching to the playback control input mode.

4. The computerized method of claim 1, wherein connecting to the wireless network comprises selecting the wireless local area network based on the relative strength of its signal compared to other available wireless local area networks.

5. The computerized method of claim 1, wherein the first channel information is configurable by a user.

6. The computerized method of claim 1, wherein the media stream comprises an audio stream, and wherein the playback parameter comprises playback volume.

7. The computerized method of claim 1, wherein the media stream comprises a video stream.

8. The computerized method of claim 1, further comprising, responsive to the first two-button press, connecting to a second media stream associated with a second streaming media channel identified by second channel information stored in the memory.

9. The computerized method of claim 1, wherein the power-up event is initiated by connection of an output device to the portable streaming media device.

10. The computerized method of claim 1, wherein connecting to a wireless network is based at least in part on configurable network information stored in the memory.

11. One or more computer-readable storage media having stored therein computer-executable instructions operable to cause the portable streaming media device to perform the computerized method of claim 1.

12. A portable computing device comprising:
an output device connector configured to turn on the computing device when an output device is connected to the output device connector;
a wireless communication module configured to connect to and communicate with wireless networks in response to a power-up event;
a memory having stored therein a list of streaming media channels;
a processing module configured to obtain and process streaming media information received from at least one of the streaming media channels via the wireless communication module; and
exterior hardware buttons configured to control one or more playback parameters in a first input mode and to control streaming media channel selection in a second input mode.

13. The portable computing device of claim 12, wherein the output device connector comprises an audio jack.

14. The portable computing device of claim 13, wherein the audio jack comprises one or more switches operable to turn on the portable computing device when a plug is inserted into the audio jack.

15. The portable computing device of claim 12, wherein the wireless communication module comprises a wireless modem.

16. The portable computing device of claim 12, wherein the processing module comprises a digital signal processor configured to decode encoded media information.

17. The portable computing device of claim 12, wherein the exterior hardware buttons are configured to:
in the first input mode, increase or decrease playback volume; and
in the second input mode, select a next streaming media channel or a previous streaming media channel from the list of streaming media channels.

18. The portable computing device of claim 12, wherein the exterior hardware buttons are configured to select a new streaming media channel from the list of streaming media channels when both buttons are pressed at the same time.

19. A portable computing device comprising:
a USB plug;
an audio output jack configured to turn on the computing device when an audio output device plug is inserted into the audio output jack;
a housing;
a battery within the housing, the battery configured to be charged when the portable computing device is connected to a power supply via the USB plug;
a wireless communication module within the housing, the wireless communication module configured to connect to and communicate with wireless networks in response to a power-up event initiated by the audio output jack;
a memory within the housing, the memory having stored therein streaming media channel information; and
a processor within the housing, the processor configured to select from plural available streaming media channels and process streaming media information received via the wireless communication module.

20. The portable computing device of claim 12, further comprising a detachable cap that covers the USB plug, the cap comprising a hole configured to retain a key ring or lanyard.
